(19) United States
(12) Patent Application Publication
(10) Pub. No.: US 2025/0287269 A1
(43) Pub. Date: Sep. 11, 2025

(54) MEDIUM ACCESS CONTROL LAYER SECURITY IN HANDOVERS

(71) Applicant: TELEFONAKTIEBOLAGET LM ERICSSON (PUBL), STOCKHOLM (SE)

(72) Inventors: Icaro Leonardo Da Silva, Stockholm (SE); Prajwol Kumar Nakarmi, Stockholm (SE)

(21) Appl. No.: 18/862,104

(22) PCT Filed: May 2, 2022
(86) PCT No.: PCT/IB2022/054051

§ 371 Date: Oct. 31, 2024

(51) Int. Cl. H04W 36/00; H04W 12/08; H04W 36/08

(52) U.S. Cl. CPC H04W 36/0016; H04W 12/08; H04W 36/0038; H04W 36/08

(57) ABSTRACT

A user equipment (UE) receives a handover command for a handover of the UE from a source network entity to a target network entity, and in response to the handover command, performing one or more actions related to Medium Access Control (MAC) layer security for communication between the UE and the target network entity.

### TECHNICAL FIELD

The disclosed subject matter relates generally to telecommunications. Certain embodiments relate more particularly to medium access control (MAC) layer security in handovers, such as inter-gNodeB handovers.

### BACKGROUND

In an Initial Access Stratum (AS) security activation procedure, during a transition from RRC_IDLE to RRC_CONNECTED, a user equipment (UE) derives a K_{gNB} key, which is used to derive integrity and encryption keys K_{RRCInt}, K_{RRCenc}, K_{UPenc} and K_{UPInt}. After deriving the encryption and integrity keys, the UE starts encryption and integrity protection at the packet data convergence protocol (PDCP) layer. It should be possible to refresh these security keys at Xn handovers, between a source gNodeB and a target gNodeB.

In New Radio (NR) and Long-Term Evolution (LTE), a key refresh occurs during handovers (though in NR there are some exceptional cases where key refresh may be skipped). Key refresh may include vertical or horizontal key derivation. In vertical key derivation, a Next Hop (NH) parameter is further bound to a target physical cell identifier (PCI) and a frequency, defined by an absolute radio frequency channel number for downlink (ARFCN-DL), before it is taken into use as a K_{gNB} in a target gNB. In handovers with horizontal key derivation the currently active K_{gNB} is further bound to the target PCI and the frequency ARFCN-DL before it is taken into use as the K_{gNB} in the target gNB. In both cases, ARFCN-DL is the absolute frequency of Synchronization Sequence Block (SSB) of the target PCell. It is not required to change AS security algorithms during intra-gNB-CU handover.

As security in the AS is running at the PDCP layer, key refresh relates to actions at the PDCP layer during handovers. Radio Resource Control (RRC) managed handovers with and without PDCP entity re-establishment are both supported. For Data Radio Bearers (DRBs) using Radio Link Control (RLC) Acknowledge Mode (AM), PDCP can either be re-established together with a security key change or initiate a data recovery procedure without a key change. For DRBs using RLC Unacknowledged Mode (UM), PDCP can either be re-established together with a security key change or remain as it is without a key change. For Signaling Radio Bearers (SRBs), PDCP can either remain as it is, discard its stored PDCP PDUs/SDUs without a key change or be re-established together with a security key change. The handover mechanism always requires the UE to reset the MAC entity and re-establish RLC.

FIG. 1 illustrates steps at the UE and the source and target gNodeBs during Xn handovers. The following description explains certain features of FIG. 1 that relate to key refresh.

Referring to FIG. 1, in a step (2), the source gNB decides to handover the UE, based on MeasurementReport and RRM information.

In a step (3), the source gNB issues an XnAP: Handover Request message to the target gNB passing a transparent RRC container with necessary information to prepare the handover at the target gNodeB. For the purpose of enabling security between the UE and the target gNodeB, the source gNodeB includes in the message the K_{gNB}* (as defined in 3GPP TS 33.501), the Next Hop Chaining Count (NCC) parameter (TS 33.501), in the Information Element (IE) AS Security Information, and the security capabilities (including the NR Encryption Algorithms and NR Integrity Protection Algorithms supported by the UE to be handed over) in the IE AS Security Capabilities.

The source gNB also includes an RRC container called HandoverPreparationInformation (defined in 3GPP TS 38.331), which includes the encryption and integrity protection algorithms currently being used by the UE and the source gNodeB for the keys in the PDCP layer, and further information for a re-establishment procedure in case of handover failure.

In a step (5), the target gNB prepares the handover and sends the HANDOVER REQUEST ACKNOWLEDGE to the source gNB, which includes a transparent container to be sent to the UE as an RRC message to perform the handover. In terms of security, the target gNodeB derives the K_{gNB} based on the K_{gNB}*, to derive the integrity keys and encryption keys for the PDCP layer, to be used between the UE and the target gNodeB after the handover. The message to the UE contains an indication of whether the UE should perform PDCP key refresh and/or PDCP re-establishment, and/or configuration of security algorithms.

In a step (6), the source gNB triggers the Uu handover by sending an RRCReconfiguration message to the UE, containing the information required to access the target cell, such as the target gNB security algorithm identifiers for the selected security algorithms. The UE refresh the PDCP keys or determines to use the previous encryption and integrity keys.

In a step (8), the UE synchronises to the target cell and completes the RRC handover procedure by sending RRCReconfigurationComplete message to target gNB. The RRCReconfigurationComplete message is transmitted on SRB1 and is both encrypted and integrity protected based on the new security keys.

A publication entitled “Data-Plane Signaling in Cellular IoT: Attacks and Defense” (https://dl.acm.org/doi/pdf/10.1145/3447993.3483255) explains that cellular networks might have some security vulnerabilities in the MAC layer/sublayer in the protocol stack of the air interface. In the current 5G NR air interface, as indicated above, security is performed only at the PDPC layer i.e., the MAC layer data is not encrypted/ciphered and/or integrity protected. The publication argues that these vulnerabilities in the MAC may lead to different types of attacks to the base station (and consequently to the overall system/area) and/or to the UE, such as: i) Radio Resource Draining by fake Buffer Status Reporting (BSR); ii) Prolonged Packet Delivery by fake Discontinuous Reception (DRX) command; iii) Flexible Throughput Limiting by fake Power Headroom (PHR); iv) retrieval of Device Localization by retrieval of Timing Advance (TA) command; v) Packet delivery loop using fake negative acknowledgement (NACK) in Radio Link Control (RLC) layer; and vi) Connection reset using fake Access Stratum Release Assistance Indication (AS RAI).

The authors propose that the MAC layer should derive new keys (named in the paper KDSenc and KDSint) to protect data-plane signaling with some characteristics:
The keys must differ from those used in PDCP;
The generation of keystream must use parameters other than PDCP Sequence Number (SN);
MAC encrypts and integrity protects each MAC control element and RLC control;
Same key hierarchy is used i.e., based on K_{eNB}, as shown in FIG. 2.

Although the authors propose the concept of security (i.e., ciphering/encryption and integrity protection) at the MAC layer, the present inventors have recognized a void concerning the handling of MAC security during handovers or mobility procedure in Connected mode. Existing AS security is associated to the PDCP layer and the existing handling during handover in RRC is only defined for the PDCP layer i.e., it does not work for the MAC layer security. Hence, it is unknown how MAC layer security would be defined during handovers.

### SUMMARY

In some embodiments of the disclosed subject matter, a method of operating a user equipment (UE), comprises receiving a handover command for a handover of the UE to a target network entity, and in response to the handover command, performing one or more actions related to Medium Access Control (MAC) layer security for communication between the UE and the target network entity.

In certain related embodiments, the one or more actions comprise at least one of the following: activation of encryption/ciphering of the MAC layer; deactivation of encryption/ciphering of the MAC layer; continuation of encryption/ciphering of the MAC layer in the target network entity without MAC security updates; continuation of encryption/ciphering of the MAC layer in the target network entity with MAC security updates; activation of integrity protection of the MAC layer; deactivation of integrity protection of the MAC layer; continuation of integrity protection of the MAC layer in the target network entity without MAC security updates; and continuation of integrity protection of the MAC layer in target network entity with MAC security updates.

In certain related embodiments, the handover command comprises a Radio Resource Control (RRC) message. In some such embodiments, the RRC message is an RRCReconfiguration message including an information element (IE) ReconfigurationWithSync.

In certain related embodiments, the source network entity comprises a source cell associated with a source network node, and wherein the target network entity comprises a target cell associated with a target network node.

In certain related embodiments, the handover command includes an indication of the one or more actions to be performed in response to the handover command. In some such embodiments, the indication comprises one or more of a UE configuration, an information element, and a parameter for the one or more actions.

In certain related embodiments, the method further comprises, in response to the handover command, initiating a random-access (RA) procedure with the target network entity according to a RA configuration included in the handover command, wherein the RA procedure comprises the UE transmitting to the target network entity a RA preamble, starting a timer, and while the timer is running receiving a Random-Access Response (RAR) from the target network node; and upon reception of the RAR generating a MAC layer msg3 including a handover complete message and transmitting the msg3 to the target network node. In some such embodiments, the RAR comprises a MAC Control Element (CE) that is integrity protected and/or encrypted. In some such embodiments, the MAC layer msg3 is integrity protected and/or encrypted. In some such embodiments, the method further comprises, in response to the MAC layer msg3, receiving a contention resolution MAC control element (CE) that is integrity protected and/or encrypted.

In some embodiments of the disclosed subject matter, a method of operating a target network node for a handover of a user equipment (UE) from a source network entity associated with a source network node to a target network entity associated with the target network node comprises receiving a handover request from the source network node, the handover request comprising Medium Access Control (MAC) layer security information, and in response to the handover request, determining an indication to be transmitted to the UE in the handover command, the indication indicating one or more actions to be performed by the UE for MAC layer security, and transmitting a handover command to the UE, the handover command comprising the indication.

In certain related embodiments, the one or more actions comprise at least one of the following: activation of encryption/ciphering of the MAC layer; deactivation of encryption/ciphering of the MAC layer; continuation of encryption/ciphering of the MAC layer in the target network entity without MAC security updates; continuation of encryption/ciphering of the MAC layer in the target network entity with MAC security updates; activation of integrity protection of the MAC layer; deactivation of integrity protection of the MAC layer; continuation of integrity protection of the MAC layer in the target network entity without MAC security updates; and continuation of integrity protection of the MAC layer in target network entity with MAC security updates.

In certain related embodiments, the handover request comprises an XnAP Handover Request message.

In certain related embodiments, the handover command comprises a Radio Resource Control (RRC) message. In some such embodiments, the RRC message is an RRCReconfiguration message including an information element (IE) ReconfigurationWithSync.

In certain related embodiments, the source network entity comprises a source cell associated with a source network node, and wherein the target network entity comprises a target cell associated with a target network node.

In certain related embodiments, the method further comprises, in response to the handover command, receiving from the UE transmitting a random access (RA) preamble, and in response to the RA preamble, transmitting a Random-Access Response (RAR) to the UE, and in response to the RAR, receiving a MAC layer msg3 including a handover complete message from the UE. In some such embodiments, the RAR comprises a MAC Control Element (CE) that is integrity protected and/or encrypted. In some such embodiments, the MAC layer msg3 is integrity protected and/or encrypted. In some such embodiments, the method further comprises, in response to the MAC layer msg3, receiving a contention resolution MAC control element (CE) that is integrity protected and/or encrypted.

In certain embodiments of the disclosed subject matter, a method of operating a source network node for a handover of a user equipment (UE) from a source network entity associated with the source network node to a target network entity associated with a target network node. The method comprises transmitting a handover request to the target network node, the handover request comprising Medium Access Control (MAC) layer security information that enables the target network node to determine one or more actions to be performed by the UE for MAC layer security.

In certain related embodiments, the one or more actions comprise at least one of the following: activation of encryption/ciphering of the MAC layer; deactivation of encryption/ciphering of the MAC layer; continuation of encryption/ciphering of the MAC layer in the target network entity without MAC security updates; continuation of encryption/ciphering of the MAC layer in the target network entity with MAC security updates; activation of integrity protection of the MAC layer; deactivation of integrity protection of the MAC layer; continuation of integrity protection of the MAC layer in the target network entity without MAC security updates; and continuation of integrity protection of the MAC layer in target network entity with MAC security updates.

In certain related embodiments, the handover request comprises an XnAP Handover Request message.

In certain related embodiments, the source network entity comprises a source cell associated with a source network node, and wherein the target network entity comprises a target cell associated with a target network node.

In some embodiments of the disclosed subject matter, a user equipment (UE) comprising processing circuitry and memory collectively configured to perform a method as indicated above.

In some embodiments of the disclosed subject matter, a target network node comprising processing circuitry and memory collectively configured to perform a method as indicated above.

In some embodiments of the disclosed subject matter a source network node comprising processing circuitry and memory collectively configured to perform a method as indicated above.

### BRIEF DESCRIPTION OF THE DRAWINGS

The drawings illustrate selected embodiments of the disclosed subject matter. In the drawings, like reference numbers indicate like features.

FIG. 1 illustrates steps at a UE and source and target gNodeBs during Xn handover.

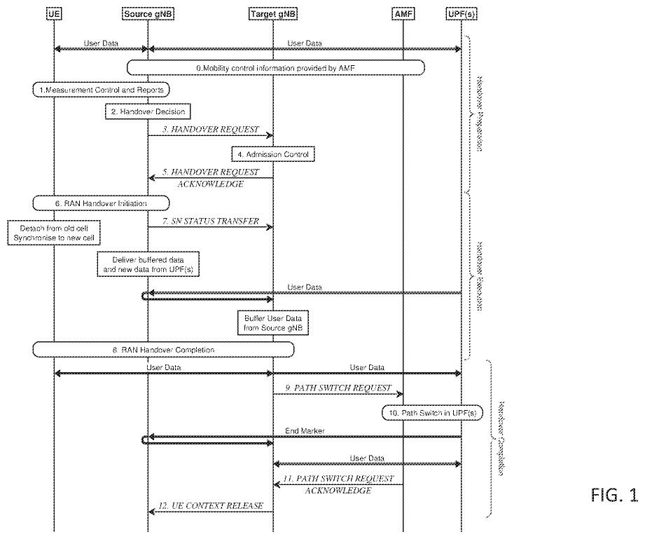

FIG. 2 illustrates a key hierarchy.

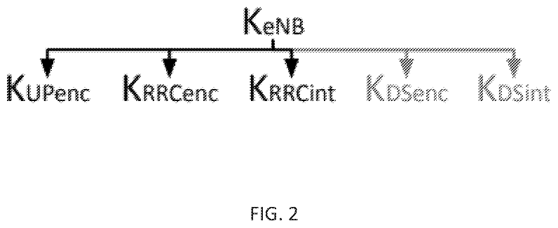

FIG. 3 illustrates a communication system according to some embodiments of the disclosed subject matter.

FIG. 4 illustrates a wireless communication device according to some embodiments of the disclosed subject matter.

FIG. 5A illustrates a radio access node according to some embodiments of the disclosed subject matter.

FIG. 5B illustrates a radio access node according to some embodiments of the disclosed subject matter.

FIG. 6 is a signal flow diagram illustrating operations performed at a UE and network nodes according to certain embodiments of the disclosed subject matter.

FIG. 7 is a signal flow diagram illustrating operations performed at a UE and network nodes according to certain embodiments of the disclosed subject matter.

FIG. 8 is a signal flow diagram illustrating operations performed at a UE and network nodes according to certain embodiments of the disclosed subject matter.

FIG. 9 is a signal flow diagram illustrating operations performed at a UE and network nodes according to certain embodiments of the disclosed subject matter.

FIG. 10 is a signal flow diagram illustrating operations performed at a UE and network nodes according to certain embodiments of the disclosed subject matter.

FIG. 11 illustrates a MAC PDU including the MAC-I* and PDCP PDU including the MAC-I for the handover complete message.

FIG. 12 illustrates a MAC PDU including the MAC-I* for the handover complete message.

### DETAILED DESCRIPTION

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the disclosed subject matter.

In the description that follows, the acronym “MAC” refers to the MAC protocol layer and stands for Medium Access Control (MAC). The acronym MAC-I refers to a Message Authentication Code for Integrity (MAC-I) and refers to bits/bytes associated to a message to indicate integrity. PDU refers to Protocol Data Unit and SDU refers to Service Data Unit. Service Data unit (SDU) refers to packets that are received by a protocol layer, while Protocol Data unit (PDU) refers to packets that are output from a protocol layer after adding the protocol layer's header to the SDU, for example IP Layer submits PDCP SDUs (IP Packets) to the PDCP layer. PDCP layer does header compression and adds PDCP header to these PDCP SDUs. PDCP Layer submits PDCP PDUs (RLC SDUs) to RLC layer.

The steps described for MAC security may comprise e.g., deriving integrity protection keys, encryption keys or both integrity protection and ciphering/encryption keys at the UE and network sides, so that both the UE and the network are able to derive the same keys for MAC security, for their secure communication in the downlink and or the uplink in the MAC layer. The steps indicated above for the network actions are not necessarily performed in the indicated order.

Handovers in NR may also be called reconfiguration with sync, in RRC terminology. A handover command may correspond to an RRC Reconfiguration message (e.g., RRCReconfiguration) including an indication/configuration for mobility, such as the Information Element (IE) Reconfiguration With Sync (e.g., ReconfigurationWithSync), including one or more parameters for the UE to access the target network entity. In general terms, this consists of the UE changing from a source entity configured by the network (e.g., source cell) to a target entity configured by the network (target cell) and start operating accordingly. The source cell is associated to a source network node e.g., source gNodeB, and the target cell is associated to a target network node e.g., target gNodeB.

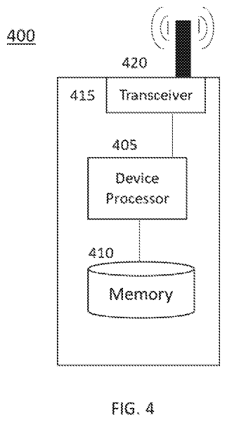

The described embodiments may be implemented in any appropriate type of communication system supporting any suitable communication standards and using any suitable components. As one example, certain embodiments may be implemented in a communication system such as that illustrated in FIG. 4. Although certain embodiments are described with respect to 3GPP systems and related terminology, the disclosed concepts are not limited to such systems.

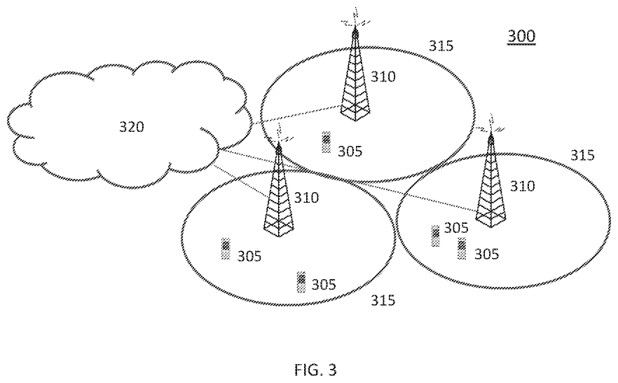

Referring to FIG. 3, a communication system 300 comprises a plurality of wireless communication devices 305 (e.g., UEs, machine type communication [MTC]/machine-to-machine [M2M] UEs) and a plurality of radio access nodes 310 (e.g., gNodeBs or other base stations). Communication system 300 is organized into cells 315, which are connected to a core network 320 via corresponding radio access nodes 310. Radio access nodes 310 are capable of communicating with wireless communication devices 305 along with any additional elements suitable to support communication between wireless communication devices or between a wireless communication device and another communication device.

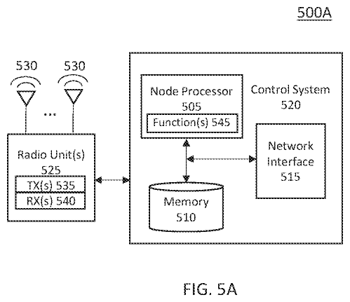

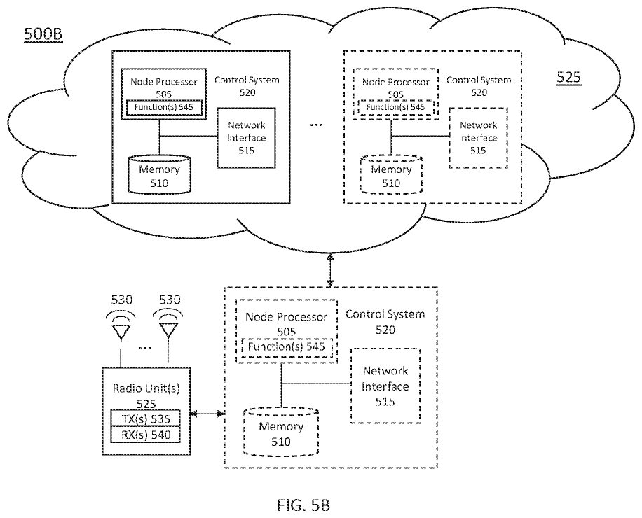

Although wireless communication devices 305 may represent communication devices that include any suitable combination of hardware and/or software, these wireless communication devices may, in certain embodiments, represent devices such as that illustrated in greater detail by FIG. 4. Similarly, although the illustrated radio access node may represent network nodes that include any suitable combination of hardware and/or software, these nodes may, in particular embodiments, represent devices such those illustrated in greater detail by FIGS. 5A and 5B.

Referring to FIG. 4, a wireless communication device 400 comprises a processor 405 (e.g., Central Processing Units [CPUs], Application Specific Integrated Circuits [ASICs], Field Programmable Gate Arrays [FPGAs], and/or the like), a memory 410, a transceiver 415, and an antenna 420. In certain embodiments, some or all of the functionality described as being provided by UEs, MTC or M2M devices, and/or any other types of wireless communication devices may be provided by the device processor executing instructions stored on a computer-readable medium, such as memory 410. Alternative embodiments may include additional components beyond those shown in FIG. 4 that may be responsible for providing certain aspects of the device's functionality, including any of the functionality described herein.

Referring to FIG. 5A, a radio access node 500A comprises a control system 520 that comprises a node processor 505 (e.g., Central Processing Units (CPUs), Application Specific Integrated Circuits (ASICs), Field Programmable Gate Arrays (FPGAs), and/or the like), memory 510, and a network interface 515. In addition, radio access node 500A comprises at least one radio unit 525 comprising at least one transmitter 535 and at least one receiver coupled to at least one antenna 530. In some embodiments, radio unit 525 is external to control system 520 and connected to control system 520 via, e.g., a wired connection (e.g., an optical cable). However, in some other embodiments, radio unit 525 and potentially antenna 530 are integrated together with control system 520. Node processor 505 operates to provide at least one function 545 of radio access node 500A as described herein. In some embodiments, the function(s) are implemented in software that is stored, e.g., in the memory 510 and executed by node processor 505.

In certain embodiments, some or all of the functionality described as being provided by a base station and/or any other type of network node may be provided by node processor 505 executing instructions stored on a computer-readable medium, such as memory 510 shown in FIG. 5A. Alternative embodiments of radio access node 500A may comprise additional components to provide additional functionality, such as the functionality described herein and/or related supporting functionality.

FIG. 5B is a block diagram that illustrates a virtualized radio access node 500B according to an embodiment of the disclosed subject matter. The concepts described in relation to FIG. 5B may be similarly applied to other types of network nodes. Moreover, other types of network nodes may have similar virtualized architectures. As used herein, the term “virtualized radio access node” refers to an implementation of a radio access node in which at least a portion of the functionality of the radio access node is implemented as a virtual component(s) (e.g., via a virtual machine(s) executing on a physical processing node(s) in a network(s)).

Referring to FIG. 5B, radio access node 500B comprises control system 520 as described in relation to FIG. 5A. Control system 520 is connected to one or more processing nodes 520 coupled to or included as part of a network(s) 525 via network interface 515. Each processing node 520 comprises one or more processors 505 (e.g., CPUs, ASICs, FPGAs, and/or the like), memory 510, and a network interface 515.

In this example, functions 545 of radio access node 500B described herein are implemented at the one or more processing nodes 520 or distributed across control system 620 and the one or more other processing nodes in any desired manner. In some embodiments, one or more functions 545 of radio access node 500B described herein are implemented as virtual components executed by one or more virtual machines implemented in a virtual environment(s) hosted by processing node(s) 520. As will be appreciated by one of ordinary skill in the art, additional signaling or communication between processing node(s) 520 and control system 520 is used in order to carry out at least some of the desired functions 545. As indicated by dotted lines, in some embodiments control system 520 may be omitted, in which case the radio unit(s) 525 communicate directly with processing node(s) 520 via appropriate network interface(s).

In some embodiments, a computer program comprises instructions that, when executed by at least one processor, cause at least one processor to carry out the functionality of a radio access node or another node implementing one or more of the functions of the radio access node in a virtual environment according to any of the embodiments described herein.

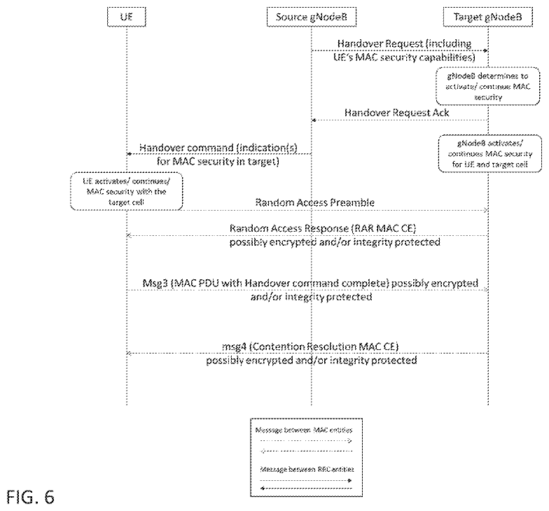

FIG. 6 illustrates certain operations performed by a UE and network nodes according to various embodiments of the disclosed subject matter.

Certain embodiments provide methods at a UE for handling MAC layer security during a handover (e.g., updating, triggering the initial activation/deactivation, re-configuration of algorithms) from a source network entity (e.g., source cell, associated to a source network node) to a target network entity (e.g., target cell, associated to a target network node). In some embodiments, a method comprises the UE receiving a handover command (e.g., an RRC message like an RRCReconfiguration including the IE ReconfigurationWithSync) and performing one or more actions related to the MAC layer security for the communication between the UE and the target network entity. The one or more actions may include, for instance, i) Activation of encryption/ciphering of MAC layer, ii) Deactivation of the encryption/ciphering of MAC layer, iii) Continuation of encryption/ciphering of MAC layer in target network entity without MAC security updates, iv) Continuation of encryption/ciphering of MAC layer in target network entity with MAC security updates, vi) Activation of integrity protection of MAC layer, vii) Deactivation of integrity protection of MAC layer, viii) Continuation of integrity protection of MAC layer in target network entity without MAC security updates, and/or ix) Continuation of integrity protection of MAC layer in target network entity with MAC security updates.

In some embodiments, a method comprises a UE performing one or more actions related to MAC layer security (e.g., encryption and/or integrity protection) for communication between the UE and a target network entity based on at least one indication (e.g., configuration, one or more parameters, information element) included in a handover command, wherein the indication indicates, e.g., that: i) MAC layer security (e.g., encryption and/or integrity protection) is to be activated, ii) MAC layer security (e.g., encryption and/or integrity protection) is to be deactivated, iii) MAC layer security (e.g., encryption and/or integrity protection) is to be continued in target cell without MAC security updates, and/or iv) MAC layer security (e.g., encryption and/or integrity protection) is continued in target cell, with MAC security updates.

Certain embodiments of the disclosed subject matter provide methods at a target network node (e.g., target gNodeB) for a handover of a UE, wherein the target network node is associated to a target network entity, such as a target network cell the UE accesses during the handover. The core idea at the target network node is the reception of a handover request from the source network node (e.g., XnAP Handover Request message), including MAC layer security information based on which the target network node determines for the UE and includes in the handover command for the UE indications indicating that: i) MAC layer security is to be activated (if not activated in the source cell, but to be activated in target cell); and/or ii) MAC layer security is to be deactivated (if activated in the source cell, but to be deactivated in the target) and/or; iii) MAC layer security is to be continued in target cell without MAC security updates and/or; iv) MAC layer security is continued in target cell, with MAC security updates, wherein MAC layer security comprises encryption/ciphering, integrity protection or both.

Depending on what the target network has determined and what it has indicated to the UE in the handover command, the target network node may also perform actions accordingly. For instance, if the target network node determines that i) MAC layer security is to be activated at the UE (if not activated in the source cell, but to be activated in target cell), the target network node also activates security at its network MAC entity, and so on. The handover command for the UE is included in the response message (e.g., Handover Request Ack) to the source network node (e.g., source gNodeB) to be forwarded from the source to the UE.

In certain embodiments of the disclosed subject matter, a source network node (e.g., source gNodeB) transmits a handover request to a target network node (e.g., XnAP Handover Request), including MAC layer security information, enabling the target network node to determine for a UE and include in the handover command for the UE indications indicating one or more of i), ii), iii) MAC layer security is to be continued in target cell without MAC security updates and iv) as indicated above.

In certain embodiments, it is possible for the UE to perform MAC layer security actions upon the handover, such as one or more of: i) Activation of encryption/ciphering of MAC layer ii) Deactivation of the encryption/ciphering of MAC layer, iii) Continuation of encryption/ciphering of MAC layer in target network entity without MAC security updates, iv) Continuation of encryption/ciphering of MAC layer in target network entity with MAC security updates, vi) Activation of integrity protection of MAC layer, vii) Deactivation of integrity protection of MAC layer, viii) Continuation of integrity protection of MAC layer in target network entity without MAC security updates, and/or ix) Continuation of integrity protection of MAC layer in target network entity with MAC security updates.

Certain embodiments may also be relevant in the context of 6G. There has been an increase in the number of functionalities performed by the MAC layer, since the late releases of LTE, to 5G NR, and the 5G evolution. In 5G advanced, for example, inter-cell mobility based on MAC layer messages is going to be supported, so that security in MAC becomes more and more relevant. Hence, in 6G, more sensitive functions enabled by MAC layer messages are expected, so that MAC security becomes even more important. It is expected that in 6G, mobility in connected mode (handover) are still going to be supported, so that MAC security during handovers may be a quite relevant technical area.

In one set of embodiments, the i) activation of encryption/ciphering of MAC layer comprises at least one of the following: the UE derives at least one encryption/ciphering key for the MAC layer (e.g., K_{MACenc} key(s), K_{MACenc-UP} key(s), K_{MACenc-CP} key(s)) for the communication between the UE and the target network entity (in downlink and/or uplink), possibly based on a ciphering/encryption algorithm for MAC layer security; the UE configures lower layers to apply encryption/ciphering (at the MAC layer). In this set of embodiments, it may be assumed that MAC layer encryption was not activated for the communication between the UE and the source network entity, so MAC encryption/ciphering is being initiated/activated for the UE and the target network entity (note: in currently existing NR or LTE handover, these set of embodiments do not exist as PDCP security is always activated in the source cell when a handover is triggered).

One advantage of this is that MAC encryption/ciphering may be started by a target cell as part of the handover procedure, even if MAC encryption/ciphering was not started at the source cell. In some variants, the activation of encryption/ciphering of MAC layer at the UE is performed in response to the indication that ciphering/encryption of MAC layer is to be activated. There may be an additional indication that encryption/ciphering is to be activated or not.

Similar actions are performed by the target network node as both the UE and the target network node need to communicate in an encrypted manner in their MAC entities. Hence, the target network node also derives at least one encryption/ciphering key for the MAC layer (e.g., K_{MACenc} key(s), K_{MACenc-UP} key(s), K_{MACenc-CP} key(s)) for the communication with the UE (in downlink and/or uplink), possibly based on a ciphering/encryption algorithm for MAC layer security; the target network node also configures lower layers to apply encryption/ciphering (at the MAC layer).

In some embodiments, the ciphering/encryption algorithm for MAC layer security to be used is the encryption/ciphering algorithm configured/indicated in the handover command for PDCP layer security, for the communication between the UE and the target network entity (e.g., the parameter cipheringAlgorithm within the IE SecurityConfig). In some variants, this step is executed by the UE if the configuration (e.g., indication parameter, field, IE) of a ciphering/encryption algorithm for MAC layer security is absent, and the encryption/ciphering algorithm configured/indicated in the handover command for PDCP layer security is present/included. In another variant this step is always executed if the encryption/ciphering algorithm configured/indicated in the handover command for PDCP layer security is present/included (assuming there would not be a configuration defined for a ciphering/encryption algorithm for MAC layer security).

In another embodiment the ciphering/encryption algorithm for MAC layer security to be used is the encryption/ciphering algorithm which was being used for PDCP layer security for the communication between the UE and the source network entity before the handover, which may be called the “current algorithm”.

In some variants, this step is executed if both the configuration of a ciphering/encryption algorithm for MAC layer security and the encryption/ciphering algorithm configured/indicated in the handover command for PDCP layer security are absent, and the UE should activate encryption/ciphering in the MAC layer for the communication between the UE and the target network entity, wherein the need to activate encryption/ciphering in the MAC layer for the communication between the UE and the target network entity may be indicated by another indication. In another variant, that is always performed executed if the encryption/ciphering algorithm configured/indicated in the handover command for PDCP layer security is absent (assuming there would not be a configuration defined for a ciphering/encryption algorithm for MAC layer security). In yet another variant, that step is always performed executed if the encryption/ciphering algorithm configured/indicated in the handover command for PDCP layer security is absent (assuming there would not be a configuration defined for a ciphering/encryption algorithm for MAC layer security), and the handover command contains an indication indicating that the need to activate encryption/ciphering in the MAC layer for the communication between the UE and the target network entity.

In some embodiments, the ciphering/encryption algorithm for MAC layer security to be used for the communication between the UE and the target network entity has a different configuration (e.g., different indication/parameter/IE) compared to the configuration/indication of the encryption/ciphering algorithm configured/indicated in the handover command for PDCP layer security. While the encryption/ciphering PDCP layer algorithm is indicated in a first parameter/field/IE e.g., the parameter cipheringAlgorithm within the IE SecurityConfig, the MAC layer encryption/ciphering algorithm is indicated in a different parameter, field, IE e.g., cipheringAlgorithmMAC within the IE SecurityConfig, or in a separate IE e.g., SecurityConfigMAC. Having algorithm differentiation gives flexibility of which algorithms to support in MAC and PDCP layers for source and target network nodes.

For example, because of cost reasons, it may be prudent that the MAC layer implements few algorithms, while the PDCP layer implements more algorithms. Or, among a set of algorithms, some may be implemented by the MAC layer and some by the PDCP layer so that there is no need for duplicate implementation in both the layers. Such a differentiation, in certain hardware/software design, could also allow parallelizing the cryptographic operations, e.g., using different hardware/software accelerators for different algorithms. In another example, different radio bearers could have different algorithm for the MAC layer security, even though the PDCP layer security has a single algorithm; thus, MAC layer security could be parallelized.

In the particular case of a handover, the network node associated to the source network entity (e.g., source gNodeB) and the network node associated to the target network entity (e.g., target gNodeB), possibly from different network manufacturers, may decide to implement different or the same encryption/ciphering algorithm(s) for MAC and PDCP layers, so that upon handovers that may be changed (if the same, they may be different, or vice versa). The fact that different parameters/configuration(s) may be used for configuring the ciphering algorithm for MAC security and for PDCP security does not preclude the usage of a common pool of algorithms the UE should or must implement. In other words, the same list of algorithms may exist for MAC and for PDCP, and it would be up to the network to decide which one to configure for each of the layers, including the possibility to configure the same algorithm for both MAC and PDCP.

In a third variant, some other transformation (like a cryptographic hash function), instead of an encryption/ciphering algorithm for the MAC layer, is indicated in the configuration in the handover command. Example of such hash functions are HMAC (hash-based message authentication code) like HMAC-SHA-256. In this variant, the said transformation could be standardized so that both parties (e.g., UE and target network node) know it beforehand and there is no need to explicitly signal it in the configuration.

In another set of embodiments, the ii) deactivation of the encryption/ciphering of MAC layer comprises at least one of the steps: the UE discards (releases/deletes/removes) the at least one (e.g., all) encryption/ciphering key for the MAC layer (e.g., K_{MACenc} key(s)), i.e., the keys which has/have been used for communication between the UE and the source network entity; and the UE discards/releases/deletes/removes the ciphering/encryption algorithm for MAC layer security from its configuration (e.g., removal from the AS security context or discards the MAC security context); the UE stops applying or configure lower layers to stop applying encryption/ciphering (at the MAC layer). In this set of embodiments, it may be assumed that MAC layer encryption was activated for the communication between the UE and the source network entity, but upon the handover it is being stopped (and in prior art NR or LTE handover, these set of embodiments do not exist as PDCP security always continues in the target cell when a handover is triggered, either using the same keys used in source cell or new keys).

In some variants, the deactivation of the encryption/ciphering of MAC layer is performed in response to the indication that MAC layer security (e.g., encryption and/or integrity protection is to be deactivated. One option to implement the indication is to define it as a parameter/IE which has Need Code R (as defined in 3GPP TS 38.331, with similar functionality) that may possibly be included in a handover command, wherein the reception of the handover command with the absence of the parameter/IE indicates the release of the ciphering/encryption of the MAC layer configuration in the handover.

One advantage of this set of embodiments is that the target network node upon receiving a handover request from a source network node may not be capable of applying encryption/ciphering for the MAC layer for an incoming UE, wherein the incoming UE is/was applying encryption/ciphering for the MAC layer with the source network entity. Hence, the target network node should have the possibility to stop encryption/ciphering at the MAC layer at the UE. Even in case the target network node is capable of applying encryption/ciphering for the MAC layer for an incoming UE there may be other reasons to stop, such as lower processing capabilities at the hardware implementing the MAC layer.

In some embodiments, upon reception of the handover command including the indication to deactivate ciphering/encryption in the MAC layer the UE determines stops encrypting/ciphering MAC messages to be transmitted to the source network entity (e.g., MAC PDUs), such as the RLC, MAC acknowledgement messages in response to the handover command (e.g., RRC Reconfiguration) which has been received.

In some embodiments, upon reception of the handover command including the indication to deactivate ciphering/encryption in the MAC layer the UE determines to stops encrypting/ciphering MAC messages to be transmitted to the target network entity (e.g., MAC PDUs), but keeps transmitting ciphered/encrypted the MAC messages to be transmitted to the source network entity (e.g., MAC PDUs), such as the RLC, MAC acknowledgement messages in response to the handover command (e.g., RRC Reconfiguration) which has been received.

In some embodiments, upon reception of the handover command including the indication to deactivate ciphering/encryption in the MAC layer the UE determines to stops encrypting/ciphering MAC messages to be transmitted to the target network entity (e.g., MAC PDUs), but keeps transmitting ciphered/encrypted the MAC messages which are already in the buffer.

In some embodiments, upon reception of the handover command the UE determines stops encrypting/ciphering MAC messages to be transmitted to the source network entity and/or to the target network entity upon performing a MAC reset operation.

In another set of embodiments, the iii) continuation of encryption/ciphering of MAC layer in target network entity without MAC security updates is done in target network entity (target cell) without MAC security updates, comprises at least one of the steps: UE continues to use for its communication with the target network entity after the handover at least one encryption/ciphering key for the MAC layer (e.g., K_{MACenc} key(s), K_{MACenc-UP} key(s), K_{MACenc-CP} key(s)) which is the same used for the communication between the UE and the source network entity (in downlink and/or uplink). In this set of embodiments, it may be assumed that MAC layer ciphering/encryption was activated for the communication between the UE and the source network entity, so it is being maintained after the handover without a refresh of MAC ciphering/encryption keys. This may be possible in case of intra-gNodeB handovers, or generically speaking handovers without a change of MAC entity at the network side. The continuation of encryption/ciphering of MAC layer in target network entity without MAC security updates is performed may be in response to an indication that the MAC layer security, e.g., encryption and/or integrity protection is to be continued without MAC security updates.

In some embodiments, the handover command includes an indication indicating that iii) MAC layer security (e.g., encryption and/or integrity protection) is to be continued in target cell without MAC security updates is a parameter, field, IE, configuration (e.g., NoMasterKeyUpdateMAC). In a variant, the absence of a parameter, field, configuration, IE (e.g., absence of MasterKeyUpdateMAC) indicates that iii) MAC layer security (e.g., encryption and/or integrity protection) is to be continued in target cell without MAC security updates.

In some embodiments, the indication included in the handover command indicating that iii) MAC layer security (e.g., encryption and/or integrity protection) is to be continued in target cell without MAC security updates is a combination of a first parameter and a second parameter wherein the first parameter indicates that MAC encryption/ciphering should be used for the communication with the target network entity, and the second parameter (or its absence) indicates that MAC encryption/ciphering should not be refreshed (i.e., that same encryption/ciphering keys used with the source network entity should be continued to be used with the target network entity).

In some embodiments, the indication included in the handover command indicating that iii) MAC layer security (e.g., encryption and/or integrity protection) is to be continued in target cell without MAC security updates is an indication that MAC reset is not to be performed upon the handover.
In some variants, the UE receives a first parameter indicating that MAC reset is not to be performed. In response to that parameter, the UE continues to apply MAC ciphering/encryption without key refresh/updated and using same ciphering/encryption keys used in source.
In another variant the UE receives the handover command with the absence of a parameter, wherein the absence indicates that MAC reset is not to be performed. In response to this absence in the handover command, the UE continues to apply MAC ciphering/encryption without key refresh/updated and using same ciphering/encryption keys used in source.
In another variant the UE receives the handover command with the absence or presence of a first parameter, wherein the presence of absence of the first parameter indicates that MAC reset is not to be performed. The handover command includes a second parameter indicating whether in the case of MAC not reset, if MAC ciphering/encryption is to be continued without MAC ciphering/encryption key refresh.

In some embodiments, if the handover command indicates that MAC is reset, the handover command also indicates that MAC encryption/ciphering keys are also refreshed/updated. Hence, if the target network node determines to reset MAC it should determine to refresh the MAC encryption/ciphering keys (if it determines to continue MAC security).

In one set of embodiments, the iv) continuation of encryption/ciphering of MAC layer in target network entity with MAC security updates is done in the target network entity (target cell), with MAC security updates), comprising the UE deriving at least one new encryption/ciphering key for the MAC layer (e.g., K_{MACenc} key(s), K_{MACenc-UP} key(s), K_{MACenc-CP} key(s)) which differs from current encryption/ciphering key(s) for the MAC layer used for the communication between the UE and the source network entity (in downlink and/or uplink). In some variants, the refresh of encryption/ciphering key for MAC layer is done with or without algorithm re-configuration/updates.

In a first embodiment the new encryption/ciphering key for the MAC layer (e.g., K_{MACenc} key(s), K_{MACenc-UP} key(s), K_{MACenc-CP} key(s)), to be used for communication between the UE and the target network entity, is/are derived (i.e., key is refreshed) based on the encryption/ciphering algorithm for the MAC layer which was being used for the communication between the UE and the source network entity. The action(s) in the first embodiment are possibly performed by the UE upon reception of a first indication in the handover command that encryption/ciphering key refresh should be performed (e.g., a parameter, field, IE, configuration), and a second indication indicating that the key refresh is based on the encryption/ciphering algorithm for the MAC layer which was being used for the communication between the UE and the source network entity. In a sub-variant, the second indication is the absence of a parameter, field, IE, wherein the parameter, field, IE could be associated to a ciphering/encryption algorithm configuration for the MAC layer, so its absence indicates that a previously configured algorithm is to be used. This second indication may be implemented as a field/parameter using Need Code M (its absence indicating the usage of a previously configured parameter).

In a variant, the encryption/ciphering algorithm for the MAC layer as used for the communication between the UE and the source network entity is the same as the encryption/ciphering algorithm for the PDCP layer as used for the communication between the UE and the source network entity.

In another variant, the encryption/ciphering algorithm for the MAC layer as used for the communication between the UE and the source network entity is different than the encryption/ciphering algorithm for the PDCP layer as used for the communication between the UE and the source network entity.

In a second embodiment the new encryption/ciphering key for the MAC layer (e.g., K_{MACenc} key(s), K_{MACenc-UP} key(s), K_{MACenc-CP} key(s)) is/are derived (key refresh) based on a new configuration for the encryption/ciphering algorithm for the MAC layer compared to the one which was used for the communication between the UE and the source network entity.

In a first variant, the ciphering/encryption algorithm for MAC layer security to be used is the encryption/ciphering algorithm configured/indicated in the handover command for PDCP layer security for the communication between the UE and the target network entity (e.g., the parameter cipheringAlgorithm within the IE SecurityConfig). In some variants, this step may be executed if the configuration of a ciphering/encryption algorithm for MAC layer security is absent, and the encryption/ciphering algorithm configured/indicated in the handover command for PDCP layer security is included.

In another variant, the ciphering/encryption algorithm for MAC layer security to be used is the encryption/ciphering algorithm used for PDCP layer security for the communication between the UE and the source network entity, which may be called the current algorithm. In some variants, this may be executed if both the configuration of a ciphering/encryption algorithm for MAC layer security and the encryption/ciphering algorithm configured/indicated in the handover command for PDCP layer security are absent, and the UE should activate encryption/ciphering in the MAC layer for the communication between the UE and the target network entity. There may be an additional indication that encryption/ciphering is to be activated or not.

In another variant the ciphering/encryption algorithm for MAC layer security to be used has a different configuration (e.g., different indication/parameter/IE) compared to the encryption/ciphering algorithm configured/indicated in the handover command for PDCP layer security. So, while the encryption/ciphering PDCP layer algorithm is indicated in e.g., the parameter cipheringAlgorithm within the IE SecurityConfig, the MAC layer encryption/ciphering algorithm may be indicated in a new parameter and/or field e.g., cipheringAlgorithmMAC within the IE SecurityConfig, or in a separate IE SecurityConfigMAC. The fact that a separate configuration may be provided does not necessarily mean that the UE is configured with different algorithms, as the pool of encryption/ciphering algorithm may still be the same for PDCP and MAC layers.

In a first set of embodiments, where encryption/ciphering is activated or continued in the target network entity after the handover, such as the cases described above i), iii), iv), the UE encrypts/ciphers at least one MAC message (e.g., MAC CE, MAC PDU) and transmits the target network entity. The target network node activates ciphering/encryption (and deciphering/decryption) to receive the encrypted/ciphered MAC message from the UE.

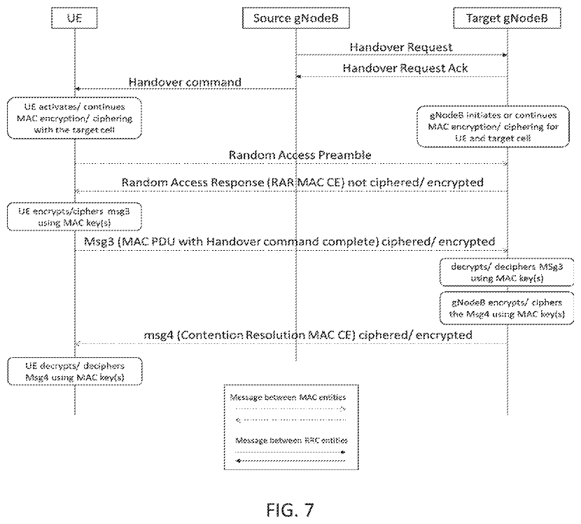

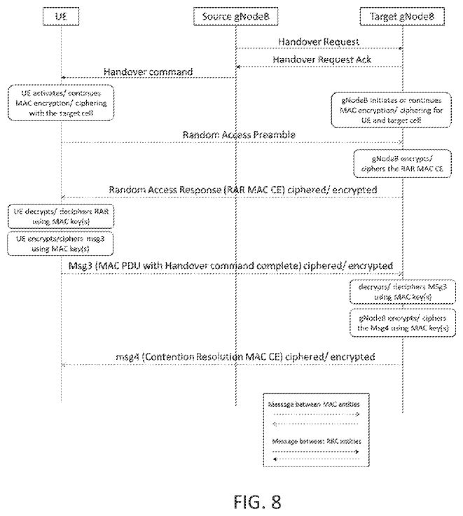

In some embodiments, the MAC message transmitted to the target network entity after the handover which is encrypted/ciphered is the MAC PDU carrying the handover complete message e.g., the MAC PDU carrying the RRC Reconfiguration Complete generated after the UE applies the handover command. Upon applying the handover command the UE initiates a random-access (RA) procedure with the target network entity (target cell) according to a RA configuration included in the handover command, wherein the RA procedure comprises the UE transmitting to the target network entity (e.g., target cell of the target network node) a RA preamble to the target cell, starting a timer and while the timer is running receiving a Random Access Response (RAR) from the target network node; upon reception of the RAR the UE generates a MAC layer msg3 including the handover complete message e.g., the MAC PDU carrying the RRC Reconfiguration Complete generated after the UE applies the handover command; the UE transmits the msg3 to the target network node, wherein the msg3 may correspond to a message transmitted on Uplink Shared Channel (UL-SCH) containing a C-RNTI MAC CE (or CCCH SDU), submitted from upper layer and associated with the UE Contention Resolution Identity, as part of a RA procedure.
(RAR is not encrypted) In a first variant, the RAR (which is msg2) received by the UE is not encrypted/ciphered by the target network node, so that upon its reception the UE does not expect to decipher/decrypt it e.g., in order to determine the temporary C-RNTI from the target network node in the RAR. In other words, the deciphering/decryption at the MAC layer is not applicable to the RAR. After the UE transmits msg3 in response to the RAR, in the case this is a contention-based random access (CBRA) procedure, the UE receives a msg4 for contention resolution.
   The msg4 comprises a UE Contention Resolution Identity MAC CE e.g., as defined in § 6.1.3.3 of 3GPP TS 38.321.
   In a first sub-variant, the msg4 is encrypted/ciphered by the target network node. This is the first MAC message the UE expects to be encrypted/ciphered. If there is a preamble collision of different UEs, the C-RNTI associated to the accepted UE is transmitted in the msg4, which is encrypted/ciphered according to the encryption/ciphering MAC layer key(s) associated to the accepted UE. Hence, the accepted UE receiving msg4 should be able to decipher/decrypt msg4 and determine that the received C-RNTI is the same as its C-RNTI (e.g., Temporary C-RNTI received in the RAR or the C-RNTI assigned in the handover command), or that the received msg4 content matches its transmitted msg3. If the UE receives msg4 and is not able to decrypt/decipher or the deciphered content does not match its C-RNTI or the transmitted content in msg3, there may be different options for UE actions, such as: a) the UE considers as if contention has not been resolved and starts a preamble re-transmission due to unsuccessful contention resolution; or the UE considers this a security failure in the MAC layer and triggers another procedure. The msg4 may correspond to the Uplink (UL) CCCH SDU, which includes the C-RNTI the UE has transmitted in msg3.
   The encryption/ciphering of msg4 at the target network node is possible as contention is being resolved and the target node determines which UE (and associated C-RNTI) is being accepted, so that it encrypts/ciphers the msg4 to be transmitted for that UE with the corresponding ciphering/encryption key(s) of the accepted UE in contention resolution. An example of a signaling flow is shown in FIG. 7.
   In a second sub-variant, contention resolution relies (at least partially) in the encryption/ciphering of msg4. The UE expects the reception of an encrypted/ciphered msg4 transmitted by the target network node. If upon reception the UE successfully deciphers/decrypts msg4 with its MAC encryption/ciphering key(s) derived/activated upon handover it means that the target network node has resolved contention with that UE, if the deciphered/decrypted content matches the contention of its transmitted msg3.
   In a third sub-variant, the msg4 is not encrypted/ciphered by the target network node. For example, the first MAC message the UE expects to be encrypted/ciphered is a first MAC PDU and/or MAC CE received after the RA procedure during the handover.
(RAR is encrypted) In a second variant, the RAR received by the UE is encrypted/ciphered by the target network node, so that upon the reception of the RAR the UE deciphers/decrypts it before it sends msg3 to the target network node and receive msg4 for contention resolution (if CBRA). Upon deciphering/decrypting the RAR the UE determines e.g., the Timing Advance (TA) and/or the C-RNTI from the target network node. Having the RAR encrypted could mitigate security/privacy attacks stemming from the information revealed by the contents of the RAR. In the recent publication entitled “Data-Plane Signaling in Cellular IoT: Attacks and Defense” (https://dl.acm.org/doi/pdf/10.1145/3447993.3483255), the authors claim that the TA can be used to estimate the UE's location. Therefore, if the RAR is encrypted during the handover, the attacker would not be able to estimate the UE's location by using the TA, which is a privacy benefit.
   In a first sub-variant, UE expects an encrypted RAR in response to a preamble transmission only if the UE is configured with Contention-Free Random Access (CFRA). The reasoning is that in this case the RA preamble and/or the time/frequency domain resource used by the UE for RA preamble transmission is known to the UE and to the target network node, so that upon preamble reception the target network node identifies the UE and knows which encryption/ciphering key to apply for encrypting/ciphering the RAR. Similarly, upon transmission of a RA preamble when configured with CFRA, the UE receives the RAR and decrypts/deciphers it, to decode the C-RNTI and/or further contention in the RAR. In this case, the RAR would be the first MAC message the UE expects to be encrypted/ciphered. An example signaling flow is shown in FIG. 8.

In another embodiment, in addition to the MAC message transmitted to the target network entity after the handover being encrypted/ciphered, i.e., the MAC PDU carrying the handover complete message, the PDCP PDU with the RRC Reconfiguration Complete generated after the UE applies the handover command is also encrypted/ciphered, but with the PDCP security keys to be used between the UE and the target network node.

In another embodiment, the MAC message transmitted to the target network entity after the handover is encrypted/ciphered, i.e., the MAC PDU carrying the handover complete message, instead of the PDCP PDU with the RRC Reconfiguration Complete generated after the UE applies the handover command being encrypted/ciphered. In one variant, that is configurable i.e., the handover command indicates whether encryption at the PDCP layer and/or at the MAC layer is to be applied in the target cell.

In another embodiment, the MAC message transmitted to the target network entity after the handover which is encrypted/ciphered is not the MAC PDU carrying the handover complete message. In other words, the MAC PDU carrying the RRC Reconfiguration Complete generated after the UE applies the handover command will not be encrypted.

In another embodiment, if MAC layer encryption/ciphering is to be activated/continued between the UE and the target network entity upon the handover, the UE only starts to apply MAC layer encryption after the RA procedure between the UE and the target network node. In other words, the first MAC message (e.g., MAC CE and/or MAC PDU) is a message transmitted after the UE has received msg4 (for contention resolution, if CBRA) or after the RAR (if CFRA).

In another embodiment, if MAC layer encryption/ciphering is to be activated/continued between the UE and the target network entity upon the handover, the UE only starts to apply MAC layer decryption/deciphering also after the RA procedure between the UE and the target network node. In other words, the first MAC message (e.g., MAC CE and/or MAC PDU) the UE expects to receive encrypted/ciphered is a message received after the UE has received msg4 (for contention resolution, if CBRA) or after it has received the RAR (if CFRA).

In one set of embodiments, the i) activation of integrity protection of MAC layer comprises at least one of the steps: the UE derives at least one integrity protection key for the MAC layer (e.g., K_{MACInt} key(s), K_{MACInt-UP} key(s), K_{MACInt-CP} key(s)) for the communication between the UE and the target network entity (in downlink and/or uplink), possibly based on an integrity algorithm for MAC layer security; the UE configures lower layers to apply integrity protection (at the MAC layer). In this set of embodiments, it may be assumed that MAC layer integrity protection was not activated for the communication between the UE and the source network entity, so MAC integrity protection is being initiated/activated for the UE and the target network entity (note: in prior art NR or LTE handover, these set of embodiments do not exist as PDCP security is always activated in the source cell when a handover is triggered). One advantage of this is that MAC integrity protection may be activated/started by a target cell as part of the handover procedure, even if MAC integrity protection was not started at the source cell. In some variants, the activation of integrity protection of MAC layer is performed in response to the indication that integrity protection of MAC layer is to be activated. There may be an additional indication that integrity protection is to be activated or not.

Similar actions are performed by the target network node as both the UE and the target network node are required to communicate in an integrity protected manner in their MAC entities. Hence, the target network node also derives at least one integrity protection key for the MAC layer (e.g., K_{MACInt} key(s), K_{MACInt-UP} key(s), K_{MACInt-CP} key(s)) for the communication with the UE (in downlink and/or uplink), possibly based on a integrity protection algorithm for MAC layer security; the target network node also configures lower layers to apply integrity protection (at the MAC layer).

In another set of embodiments, the ii) deactivation of the integrity protection of MAC layer comprises at least one of the steps: the UE discards (releases/deletes/removes) the at least one (e.g., all) integrity protection key for the MAC layer (e.g., K_{MACInt} key(s)), i.e., the keys which has/have been used for communication between the UE and the source network entity; and the UE discards/releases/deletes/removes the integrity protection algorithm for MAC layer security from its configuration (e.g., removal from the AS security context or discards the MAC security context); the UE stops applying or configure lower layers to stop applying integrity protection (at the MAC layer) and/or performing integrity verification. In this set of embodiments, it may be assumed that MAC layer integrity protection was activated for the communication between the UE and the source network entity, but upon the handover it is being stopped (and in prior art NR or LTE handover, these set of embodiments do not exist as PDCP security always continues in the target cell when a handover is triggered, either using the same keys used in source cell or new keys).

In some variants, the deactivation of the integrity protection of MAC layer is performed in response to the indication that MAC layer security (e.g., encryption and/or integrity protection is to be deactivated). One option to implement the indication is to define it as a parameter/IE which has Need Code R that may possibly be included in a handover command, wherein the reception of the handover command with the absence of the parameter/IE indicates the release of the integrity protection of the MAC layer configuration in the handover.

One advantage of this set of embodiments is that the target network node upon receiving a handover request from a source network node may not be capable of applying integrity protection for the MAC layer for an incoming UE, wherein the incoming UE is/was applying integrity protection for the MAC layer with the source network entity. Hence, the target network node should have means to stop integrity protection at the MAC layer at the UE. Even in case the target network node is capable of applying integrity protection for the MAC layer for an incoming UE there may be other reasons to stop, such as lower processing capabilities at the hardware implementing the MAC layer, data rates limitation, size of a transport block, or any other reason related to radio resources.

In some embodiments, upon reception of the handover command including the indication to deactivate integrity protection in the MAC layer the UE determines stops integrity protection to the MAC messages to be transmitted to the source network entity (e.g., MAC PDUs), such as the RLC, MAC acknowledgement messages in response to the handover command (e.g., RRC Reconfiguration) which has been received.

In some embodiments, upon reception of the handover command including the indication to deactivate integrity protection in the MAC layer the UE determines to stops integrity protection MAC messages to be transmitted to the target network entity (e.g., MAC PDUs), but keeps transmitting integrity protected MAC messages to the source network entity (e.g., MAC PDUs), such as the RLC, MAC acknowledgement messages in response to the handover command (e.g., RRC Reconfiguration) which has been received.

In some embodiments, upon reception of the handover command including the indication to deactivate integrity protection in the MAC layer the UE determines to stops integrity protection to the MAC messages to be transmitted to the target network entity (e.g., MAC PDUs), but keeps transmitting integrity protected MAC messages which are already in the buffer.

In some embodiments, upon reception of the handover command the UE determines stops integrity protection to the MAC messages to be transmitted to the source network entity and/or to the target network entity upon performing a MAC reset operation.

In another set of embodiments, the iii) continuation of integrity protection of MAC layer in target network entity without MAC security updates is done in target network entity (target cell) without MAC security updates, comprises at least one of the steps: UE continues to use for its communication with the target network entity after the handover at least one integrity protection key for the MAC layer (e.g., K_{MACenc} key(s), K_{MACenc-UP} key(s), K_{MACenc-CP} key(s)) which is the same used for the communication between the UE and the source network entity (in downlink and/or uplink). In this set of embodiments, it may be assumed that MAC layer integrity protection was activated for the communication between the UE and the source network entity, so it is being maintained after the handover without a refresh of MAC integrity protection keys. This may be possible in case of intra-gNodeB handovers, or generically speaking handovers without a change of MAC entity at the network side. The continuation of integrity protection of MAC layer in target network entity without MAC security updates is performed may be in response to an indication that the MAC layer security, e.g., integrity protection is to be continued without MAC security updates.

In some embodiments, the handover command includes an indication indicating that iii) MAC layer security (e.g., encryption and/or integrity protection) is to be continued in target cell without MAC security updates is a parameter, field, IE, configuration (e.g., NoMasterKeyUpdateMAC). In a variant, the absence of a parameter, field, configuration, IE (e.g., absence of MasterKeyUpdateMAC) indicates that iii) MAC layer security (e.g., encryption and/or integrity protection) is to be continued in target cell without MAC security updates.

In some embodiments, the indication included in the handover command indicating that iii) MAC layer security (e.g., integrity protection) is to be continued in target cell without MAC security updates is a combination of a first parameter and a second parameter wherein the first parameter indicates that MAC integrity protection should be used for the communication with the target network entity, and the second parameter (or its absence) indicates that MAC integrity protection should not be refreshed (i.e., that same integrity protection keys used with the source network entity should be continued to be used with the target network entity).

In some embodiments, the indication included in the handover command indicating that iii) MAC layer integrity protection is to be continued in target cell without MAC security updates is an indication that MAC reset is not to be performed upon the handover.
In some variants, the UE receives a first parameter indicating that MAC reset is not to be performed. In response to that parameter, the UE continues to apply MAC integrity protection without key refresh/updated and using same integrity protection keys used in source.
In another variant the UE receives the handover command with the absence of a parameter, wherein the absence indicates that MAC reset is not to be performed. In response to this absence in the handover command, the UE continues to apply MAC integrity protection without key refresh/updated and using same integrity protection keys used in source.
In another variant the UE receives the handover command with the absence or presence of a first parameter, wherein the presence of absence of the first parameter indicates that MAC reset is not to be performed. The handover command includes a second parameter indicating whether in the case of MAC not reset, if MAC integrity protection is to be continued without MAC integrity protection key refresh.

In some embodiments, if the handover command indicates that MAC is to be reset (i.e., UE resets MAC entity), the handover command also indicates that MAC integrity protection keys are refreshed/updated. Hence, if the target network node determines to reset MAC it should include the indication for the UE to refresh the MAC integrity protection keys (if it determines to continue MAC security).

In one set of embodiments, the iv) continuation of integrity protection of MAC layer in target network entity with MAC security updates is done in the target network entity (target cell), with MAC security updates), comprising the UE deriving at least one new integrity protection key for the MAC layer (e.g., K_{MACInt} key(s), K_{MACInt-UP} key(s), K_{MACInt-CP} key(s)) which differs from current integrity protection key(s) for the MAC layer used for the communication between the UE and the source network entity (in downlink and/or uplink). In some variants, the refresh of integrity protection key for MAC layer is done with or without algorithm re-configuration/updates.

In a first embodiment the new integrity protection key for the MAC layer (e.g., K_{MACInt} key(s), K_{MACInt-UP} key(s), K_{MACInt-CP} key(s)), to be used for communication between the UE and the target network entity, is/are derived (i.e., key is refreshed) based on the integrity protection algorithm for the MAC layer which was being used for the communication between the UE and the source network entity. The action(s) in the first embodiment are possibly performed by the UE upon reception of a first indication in the handover command that integrity protection key refresh should be performed (e.g., a parameter, field, IE, configuration), and a second indication indicating that the key refresh is based on the integrity protection algorithm for the MAC layer which was being used for the communication between the UE and the source network entity. In a sub-variant, the second indication is the absence of a parameter, field, IE, wherein the parameter, field, IE could be associated to a integrity protection algorithm configuration for the MAC layer, so its absence indicates that a previously configured algorithm is to be used. This second indication may be implemented as a field/parameter using Need Code M (its absence indicating the usage of a previously configured parameter).

In a variant, the integrity protection algorithm for the MAC layer as used for the communication between the UE and the source network entity is the same as the integrity protection algorithm for the PDCP layer as used for the communication between the UE and the source network entity.

In another variant, the integrity protection algorithm for the MAC layer as used for the communication between the UE and the source network entity is different than the integrity protection algorithm for the PDCP layer as used for the communication between the UE and the source network entity.

In a second embodiment the new integrity protection key for the MAC layer (e.g., K_{MACInt} key(s), K_{MACInt-UP} key(s), K_{MACInt-CP} key(s)), is/are derived (key refresh) based on a new configuration for the encryption/ciphering algorithm for the MAC layer compared to the one which was used for the communication between the UE and the source network entity.

In a first variant, the integrity protection algorithm for MAC layer security to be used is the integrity protection algorithm configured/indicated in the handover command for PDCP layer security for the communication between the UE and the target network entity (e.g., the parameter integrityAlgorithm within the IE SecurityConfig). In some variants, this step may be executed if the configuration of a integrity protection algorithm for MAC layer security is absent, and the integrity protection algorithm configured/indicated in the handover command for PDCP layer security is included.

In another variant, the integrity protection algorithm for MAC layer security to be used is the integrity protection algorithm used for PDCP layer security for the communication between the UE and the source network entity, which may be called the current algorithm. In some variants, this may be executed if both the configuration of an integrity protection algorithm for MAC layer security and the integrity protection algorithm configured/indicated in the handover command for PDCP layer security are absent, and the UE should activate integrity protection in the MAC layer for the communication between the UE and the target network entity. There may be an additional indication that integrity protection is to be activated or not.

In another variant the integrity protection algorithm for MAC layer security to be used has a different configuration (e.g., different indication/parameter/IE) compared to the integrity protection algorithm configured/indicated in the handover command for PDCP layer security. So, while the encryption/ciphering PDCP layer algorithm is indicated in e.g., the parameter integrity Algorithm within the IE SecurityConfig, the MAC layer encryption/ciphering algorithm may be indicated in a new parameter and/or field e.g., integrityAlgorithmMAC within the IE SecurityConfig, or in a separate IE SecurityConfigMAC. The fact that a separate configuration may be provided does not necessarily mean that the UE is configured with different algorithms, as the pool of integrity protection algorithm may still be the same for PDCP and MAC layers.

In a first set of embodiments, in the cases integrity protection is activated or continued in the target network entity after the handover, such as the cases described above vi) Activation of integrity protection of MAC layer, viii) Continuation of integrity protection of MAC layer in target network entity without MAC security updates; and/or ix) Continuation of integrity protection of MAC layer in target network entity with MAC security updates, the UE integrity protects (e.g., by including a MAC-I*) at least one MAC message (e.g., MAC CE, MAC PDU, MAC SDU) and transmits the target network entity. The target network node activates integrity protection to verify the received MAC message from the UE, and to possibly transmit MAC messages also integrity protected. The data unit in the MAC layer (e.g., the MAC PDU, MAC SDU, MAC SDU+header) that is integrity protected is the MAC PDU header and the data part of the PDU, possibly before ciphering (e.g., MAC SDU). As a result of the handover procedure in the method for these cases, the integrity protection function at the MAC layer is activated or continued.

The method also comprises further details concerning the calculation of the MAC-I* to be included in the MAC PDU carrying e.g., the RRC Reconfiguration Complete message, or any other message equivalent to a handover complete (or to be verified by the UE for a downlink message). Some examples of required inputs to the integrity protection function include one or more of:
A logical channel identifier, which in the case of initial security activation it would be associated to the Signaling Radio Bearer (SRB1), which is the bearer for the transmission of the RRC Reconfiguration complete to the target network node.
A MAC layer identifier for the UE, such as a Cell-Radio Network Temporary Identity (C-RNTI), wherein the C-RNTI is the one assigned during a RA procedure with the target cell, or the C-RNTI assigned in the handover command.
One or more keys for MAC integrity protection key e.g., K_{MACInt}, derived during the RRC procedure.

At transmission, the UE computes the value of the MAC-I* field and at reception it verifies the integrity of the MAC PDU carrying the RRC message by calculating the X-MAC* based on the input parameters as specified above. If the calculated X-MAC* corresponds to the received MAC-I*, integrity protection is verified successfully.

In some embodiments, the MAC message transmitted to the target network entity after the handover which is integrity protected is the MAC PDU carrying the handover complete message e.g., the MAC PDU carrying the RRC Reconfiguration Complete generated after the UE applies the handover command. Upon applying the handover command the UE initiates a random-access (RA) procedure with the target network entity (target cell) according to a RA configuration included in the handover command, wherein the RA procedure comprises the UE transmitting to the target network entity (e.g., target cell of the target network node) a RA preamble to the target cell, starting a timer and while the timer is running receiving a Random Access Response (RAR) from the target network node; upon reception of the RAR the UE generates a MAC layer msg3 including the handover complete message e.g., the MAC PDU carrying the RRC Reconfiguration Complete generated after the UE applies the handover command, and includes a MAC-I* which is calculated based on the integrity protection key(s) for the MAC layer (e.g., K_{MACInt} key(s), K_{MACInt-UP} key(s), K_{MACInt-CP} key(s)). The UE transmits the msg3 to the target network node, wherein the msg3 may correspond to a message transmitted on Uplink Shared Channel (UL-SCH) containing a C-RNTI MAC CE (or CCCH SDU), submitted from upper layer and associated with the UE Contention Resolution Identity, as part of a RA procedure.

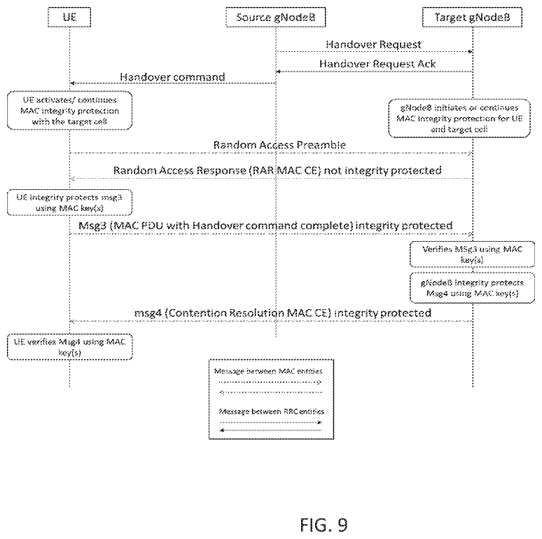

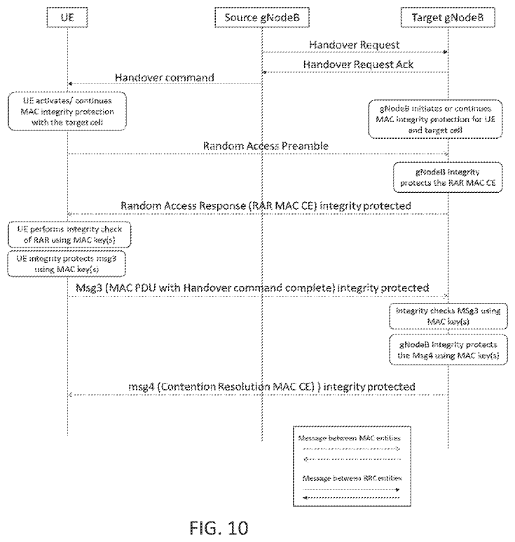

The method comprises variants regarding whether other messages in the random-access procedure are integrity protected or not, such as the following:
(RAR is not integrity protected) In a first variant, the RAR received by the UE is not integrity protected by the target network node, so that upon its reception the UE does not expect to verify integrity. After the UE transmits msg3 in response to the RAR, in the case this is a contention-based random access (CBRA) procedure, the UE receives a msg4 for contention resolution.
   The msg4 comprises a UE Contention Resolution Identity MAC CE e.g., as defined in § 6.1.3.3 of 3GPP TS 38.321.
   In a first sub-variant, the msg4 is integrity protected by the target network node. This is the first MAC message the UE expects to be integrity protected. If there is a preamble collision of different UEs, the C-RNTI associated to the accepted UE is transmitted in the msg4, which is integrity protected according to the integrity protection MAC layer key(s) associated to the accepted UE. Hence, the accepted UE receiving msg4 should be able to verify msg4 and determine that the received C-RNTI is the same as its C-RNTI (e.g., Temporary C-RNTI received in the RAR or the C-RNTI assigned in the handover command). If the UE receives msg4 and is not able to verify integrity, there may be different options for UE actions, such as: a) the UE considers as if contention has not been resolved e.g., and stats a preamble re-transmission due to unsuccessful contention resolution; or the UE considers this a security failure in the MAC layer and triggers another procedure.
   The integrity protection of msg4 at the target network node is possible as contention is being resolved and the target node determines which UE (and associated C-RNTI) is being accepted, so that it integrity protects the msg4 to be transmitted for that UE with the corresponding ciphering/encryption key(s) of the accepted UE in contention resolution. An example of a signaling flow is shown in FIG. 9.
   In a second sub-variant, contention resolution relies (at least partially) in the integrity protection of msg4. In other words, it relies on the bits/bytes of the MAC-I* included in msg4. The UE expects the reception of an integrity protected msg4 transmitted by the target network node (e.g., wherein the UE's C-RNTI could have been used as input to calculate the MAC-I*). If upon reception the UE successfully verifies msg4 with its MAC integrity protection key(s) derived/activated upon handover it means that the target network node has resolved contention with that UE. This opens up for the possibility of skipping the inclusion of the C-RNTI in msg4 (or in more general terms a contention resolution identity, like the C-RNTI MAC CE), which may be relevant for saving the number of bits/bytes in the RAR, which now would include more its/bytes of the MAC-I*. Like that, it might be possible to transmit fewer bits in msg4 and still be able to resolve contention, based on the common understanding of UE and network of security keys on the MAC layer. Else, if a UE transmits msg3 and receives a msg4 for which it does not pass the integrity check (i.e., it does not verify), the UE considers as if contention has not been resolved e.g., and triggers a preamble re-transmission due to unsuccessful contention resolution.
   In a third sub-variant, the msg4 is not integrity protected by the target network node. For example, the first MAC message the UE expects to be integrity protected is a first MAC PDU and/or MAC CE received after the RA procedure during the handover.
(RAR is integrity protected) In a second variant, the RAR received by the UE is integrity protected by the target network node, so that upon the reception of the RAR the UE performs an integrity checks, to verify integrity, before it transmits msg3 to the target network node and receive msg4 for contention resolution (if CBRA). Upon checking/verifying the integrity the RAR the UE determines e.g., the C-RNTI from the target network node. Integrity protection of RAR would prevent an attacker from tampering the content of RAR and creating unintended affects, e.g., tampering of TA would disturb the expected timing advances that UE applies to the msg3.
   In a first sub-variant, UE expects an integrity protected RAR in response to a preamble transmission only if the UE is configured with Contention-Free Random Access (CFRA). The reasoning is that in this case the RA preamble and/or the time/frequency domain resource used by the UE for RA preamble transmission is known to the UE and to the target network node, so that upon preamble reception the target network node identifies the UE and knows which integrity protection key to apply for calculating the MAC-I* to be included in the RAR. Similarly, upon transmission of a RA preamble when configured with CFRA, the UE receives the RAR and performs its integrity check, to obtain the C-RNTI and/or further contention in the RAR. In this case, the RAR would be the first MAC message the UE expects to be integrity protected. An example of a signaling flow is shown in FIG. 10.

In another embodiment, denoted option a), in addition to the MAC message transmitted to the target network entity after the handover being integrity protected, i.e., the MAC PDU carrying the handover complete message including a MAC-I*, the PDCP PDU with the RRC Reconfiguration Complete generated after the UE applies the handover command is also integrity protected, but with the PDCP security keys to be used between the UE and the target network node. In option a), the UE generates the handover complete message (RRC Reconfiguration Complete) and at its PDCP entity generates the bits/bytes used for integrity protection, denoted here as MAC-I or MAC-I_{PDCP layer} to create the PDCP PDU to be transmitted to the PDCP entity at the target network node. At the MAC layer, the UE also generates a MAC PDU including the MAC SDU (including the handover complete message) and generates a header (H) and the bits/bytes used for integrity protection (MAC-I* or MAC-I_{MAC layer}).

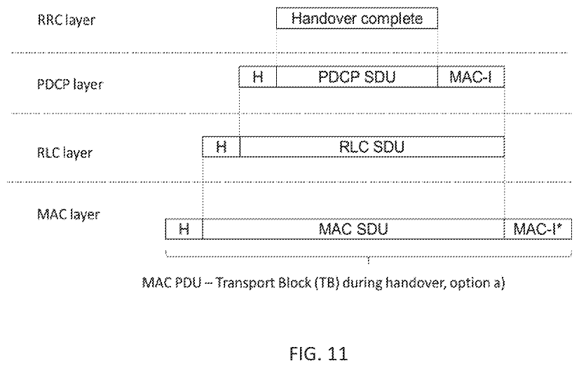

FIG. 11 shows an example of option a). More specifically, FIG. 11 illustrates a MAC PDU including the MAC-I* and PDCP PDU including the MAC-I for the handover complete message.

In another embodiment, denoted option b), the MAC message transmitted to the target network entity after the handover is integrity protected, i.e., the MAC PDU carrying the handover complete message, instead of the PDCP PDU with the RRC Reconfiguration Complete generated after the UE applies the handover command being integrity protected. In one variant, that is configurable i.e., the handover command indicates whether encryption at the PDCP layer and/or at the MAC layer is to be applied in the target cell. In option b) the UE generates in the MAC layer the MAC PDU including the MAC SDU, a header (H) and the bits/bytes used for integrity protection (MAC-I* or MAC-I_{MAC layer}) only, i.e., there is no PDCP integrity protection. A figure shows an example of option b):

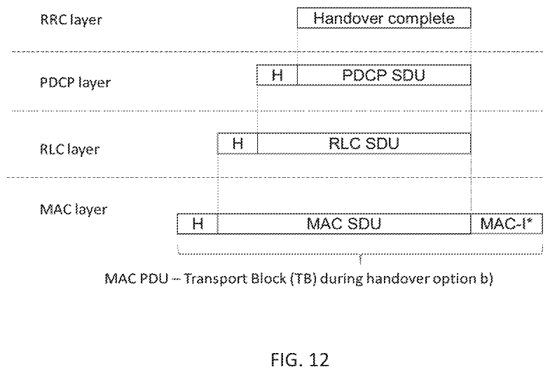

FIG. 12 illustrates a MAC PDU including the MAC-I* for the handover complete message.

In another embodiment, the MAC message transmitted to the target network entity after the handover which is encrypted/ciphered is not the MAC PDU carrying the handover complete message. In other words, the MAC PDU carrying the RRC Reconfiguration Complete generated after the UE applies the handover command will not be encrypted.

In another embodiment, if MAC layer encryption/ciphering is to be activated/continued between the UE and the target network entity upon the handover, the UE only starts to apply MAC layer encryption/after the RA procedure between the UE and the target network node. In other words, the first MAC message (e.g., MAC CE and/or MAC PDU) is a message transmitted after the UE has received msg4 (for contention resolution, if CBRA) or after the RAR (if CFRA).

In another embodiment, if MAC layer encryption/ciphering is to be activated/continued between the UE and the target network entity upon the handover, the UE only starts to apply MAC layer decryption/deciphering also after the RA procedure between the UE and the target network node. In other words, the first MAC message (e.g., MAC CE and/or MAC PDU) the UE expects to receive encrypted/ciphered is a message received after the UE has received msg4 (for contention resolution, if CBRA) or after it has received the RAR (if CFRA).

In a set of embodiments, the source network node transmits to the target network node one or more indication(s) of a security capability associated to MAC layer security, such as in the Handover Request message. Upon reception, the target network node considers the at least one capability as part of the UE context and/or part of the security context and/or part of the AS security context. The target network node, upon receiving the one or more indication(s) of a security capability associated to MAC layer security, e.g., in the handover request, determines whether it is going to configure or not the UE with MAC layer ciphering/encryption and/or MAC layer integrity protection.

In some embodiments, the source network node indicates to the target network node if and which ciphering/encryption algorithm and/or which integrity algorithms for MAC security was in use at the source network node. The target network node may use this indication to determine if and which ciphering/encryption algorithm and/or which integrity algorithms for MAC security is to be activated the target network node.

In some embodiments, the source network node does not transmit any indication of UE's security capability associated to MAC layer security.

In some embodiments, the target network node obtains the UE's security capability associated to MAC layer security from a core network node, e.g, AMF.

In some embodiments, if the target network node determines to configure the UE with MAC layer ciphering/encryption, the target network node determines the ciphering/encryption algorithm for MAC layer and configures the UE accordingly (e.g., in the handover command in the Handover Request Ack message to the source network node).

In some embodiments, if the target network node determines to configure the UE with MAC layer integrity protection, the target network node determines the integrity protection algorithm for MAC layer and configures the UE accordingly (e.g., in the handover command in the Handover Request Ack message to the source network node). The one or more indication(s) of a security capability associated to MAC layer security mentioned above may be one or more of:
At least one indication that ciphering/encryption in the MAC layer is supported.
   This may be relevant if ciphering/encryption in the MAC layer is an optional feature;
   There could be one indication, or multiple indications. In the case of multiple indication, there may be indication per MAC message type (e.g., MAC CE of a first type or second type, MAC CEs and MAC PDUs) and/or direction (MAC message in the downlink, MAC message in the Uplink. For example, it may be optional to cipher/encrypt different types of MAC CEs (e.g., associated to different logical channel identifiers) and, the UE can indicate that is capable of ciphering/encryption of a MAC CE of a second type, and vice versa.
At least one indication of ciphering/encryption algorithm(s) supported for the MAC layer, such as a list of supported algorithms. There may be mandatory algorithms the UE shall support, and the network is aware of i.e., would not need to be signaled.
At least one indication that integrity protection in the MAC layer is supported, such as a list of supported algorithms.
   This may be relevant if integrity protection in the MAC layer is an optional feature;
   There could be one indication, or multiple indications. In the case of multiple indication, there may be indication per MAC message type (e.g., MAC CE of a first type or second type, MAC CEs and MAC PDUs) and/or direction (MAC message in the downlink, MAC message in the Uplink. For example, it may be optional to integrity protect/verify integrity of different types of MAC CEs (e.g., associated to different logical channel identifiers) and, the UE can indicate that is capable of integrity protect/verify integrity of a MAC CE of a second type, and vice versa.

While the disclosed subject matter has been presented above with reference to various embodiments, it will be understood that various changes in form and details may be made to the described embodiments without departing from the overall scope of the disclosed subject matter.

1. A method of operating a user equipment (UE), comprising:
receiving a handover command for a handover of the UE to a target network entity; and
in response to the handover command, performing one or more actions related to Medium Access Control (MAC) layer security for communication between the UE and the target network entity.

2. The method of claim 1, wherein the one or more actions comprise at least one of the following:
activation of encryption/ciphering of the MAC layer;
deactivation of encryption/ciphering of the MAC layer;
continuation of encryption/ciphering of the MAC layer in the target network entity without MAC security updates;
continuation of encryption/ciphering of the MAC layer in the target network entity with MAC security updates;
activation of integrity protection of the MAC layer;
deactivation of integrity protection of the MAC layer;
continuation of integrity protection of the MAC layer in the target network entity without MAC security updates; and
continuation of integrity protection of the MAC layer in target network entity with MAC security updates.

3. The method of claim 1, wherein the handover command comprises a Radio Resource Control (RRC) message.

4. The method of claim 3, wherein the RRC message is an RRCReconfiguration message including an information element (IE) ReconfigurationWithSync.

5. (canceled)

6. The method of claim 1, wherein the handover command includes an indication of the one or more actions to be performed in response to the handover command.

7. The method of claim 6, wherein the indication comprises one or more of a UE configuration, an information element, and a parameter for the one or more actions.

8. The method of claim 1, further comprising:
in response to the handover command, initiating a random-access (RA) procedure with the target network entity according to a RA configuration included in the handover command, wherein the RA procedure comprises the UE transmitting to the target network entity a RA preamble, starting a timer, and while the timer is running receiving a Random-Access Response (RAR) from the target network node; and
upon reception of the RAR generating a MAC layer msg3 including a handover complete message and transmitting the msg3 to the target network node.

9-10. (canceled)

11. The method of claim 8, further comprising:
in response to the MAC layer msg3, receiving a contention resolution MAC control element (CE) that is integrity protected and/or encrypted.

12. A method of operating a target network node for a handover of a user equipment (UE) from a source network entity associated with a source network node to a target network entity associated with the target network node, the method comprising:
receiving a handover request from the source network node, the handover request comprising Medium Access Control (MAC) layer security information; and
in response to the handover request, determining an indication to be transmitted to the UE in the handover command, the indication indicating one or more actions to be performed by the UE for MAC layer security; and
transmitting a handover command to the UE, the handover command comprising the indication.

13. The method of claim 12, wherein the one or more actions comprise at least one of the following:
activation of encryption/ciphering of the MAC layer;
deactivation of encryption/ciphering of the MAC layer;
continuation of encryption/ciphering of the MAC layer in the target network entity without MAC security updates;
continuation of encryption/ciphering of the MAC layer in the target network entity with MAC security updates;
activation of integrity protection of the MAC layer;
deactivation of integrity protection of the MAC layer;
continuation of integrity protection of the MAC layer in the target network entity without MAC security updates; and
continuation of integrity protection of the MAC layer in target network entity with MAC security updates.

14. The method of claim 12, wherein the handover request comprises an XnAP Handover Request message.

15-16. (canceled)

17. The method of claim 12, wherein the source network entity comprises a source cell associated with a source network node, and wherein the target network entity comprises a target cell associated with a target network node.

18. The method of claim 12, further comprising:
in response to the handover command, receiving from the UE transmitting a random access (RA) preamble, and in response to the RA preamble, transmitting a Random-Access Response (RAR) to the UE; and
in response to the RAR, receiving a MAC layer msg3 including a handover complete message from the UE.

19. The method of claim 18, wherein the RAR comprises a MAC Control Element (CE) that is integrity protected and/or encrypted.

20. The method of claim 18, wherein the MAC layer msg3 is integrity protected and/or encrypted.

21. The method of claim 18, further comprising:
in response to the MAC layer msg3, receiving a contention resolution MAC control element (CE) that is integrity protected and/or encrypted.

22. A method of operating a source network node for a handover of a user equipment (UE) from a source network entity associated with the source network node to a target network entity associated with a target network node, the method comprising:
transmitting a handover request to the target network node, the handover request comprising Medium Access Control (MAC) layer security information that enables the target network node to determine one or more actions to be performed by the UE for MAC layer security.

23. The method of claim 22, wherein the one or more actions comprise at least one of the following:
activation of encryption/ciphering of the MAC layer;
deactivation of encryption/ciphering of the MAC layer;
continuation of encryption/ciphering of the MAC layer in the target network entity without MAC security updates;
continuation of encryption/ciphering of the MAC layer in the target network entity with MAC security updates;
activation of integrity protection of the MAC layer;
deactivation of integrity protection of the MAC layer;
continuation of integrity protection of the MAC layer in the target network entity without MAC security updates; and
continuation of integrity protection of the MAC layer in target network entity with MAC security updates.

24-28. (canceled)
